(19) United States
(12) Patent Application Publication
(10) Pub. No.: US 2004/0220785 A1
(43) Pub. Date: Nov. 4, 2004

(54) Computational model for transdermal drug delivery

(76) Inventors: William W. Van Osdol, Mountain View, CA (US); Peter M. Pinsky, Stanford, CA (US); Jee E. Rim, Stanford, CA (US)

Correspondence Address: PHILIP S. JOHNSON, JOHNSON & JOHNSON, ONE JOHNSON & JOHNSON PLAZA, NEW BRUNSWICK, NJ, 08933-7003, US

(21) Appl. No.: 10/763,148

(22) Filed: Jan. 21, 2004

Related U.S. Application Data
(60) Provisional application No. 60/441,420, filed on Jan. 21, 2003.

(51) Int. Cl. G06F 17/10

(52) U.S. Cl. 703/2

(57) ABSTRACT

The present invention includes a method of modeling multicomponent nonlinear diffusion in heterogeneous media. In particular, the finite element method has been employed to model nonlinear diffusion of two components through a heterogeneous media, with the diffusivities and partition coefficients taking on different values in each compartment. The diffusivities and partition coefficients were modeled as being concentration dependent, and the finite element formulation presented here is applicable to general functional forms for the diffusivities and partition coefficients. The capability to model concentration-dependent partitioning of the substances at the boundaries between the vehicle and the skin, and between the different layers of the skin is demonstrated using the Lagrange multiplier method. The Lagrange multiplier method, with the interface flux as Lagrange multipliers, allows a robust treatment of nonlinear partition coefficients.

### CROSS REFERENCE TO RELATED APPLICATIONS

This application claims the benefit of Provisional Application No. 60/441,420, filed Jan. 21, 2003.

### BACKGROUND

1. Field of the Invention

The present invention relates to the mathematical modeling of diffusive systems. In particular, the present invention is directed to a computational model for simulating non-linear diffusion of multicomponent systems through heterogeneous domains.

2. State of the Art

Systemic delivery of drugs by percutaneous permeation (transdermal drug delivery) offers several advantages over immediate release oral dosing. Principal among these are the avoidance of first-pass metabolism in the gastrointestinal tract and liver, the possibility of providing constant plasma concentrations of drug, and the opportunity for multi-day dosing. It is also possible to reduce the rate and severity of adverse events. Transdermal delivery devices (“patches”) are designed to deliver drug from the patch through the intervening skin layers to the underlying microvasculature. Transdermal patches have been marketed for almost 20 years, with perhaps 10 different small molecules (molecular weight <500 amu) now delivered transdermally.

A major obstacle to the wider application of transdermal patches is the low skin permeability of many drugs, which prevents effective dosing from patches of acceptable size. In some cases, however, chemical means permit alteration of the structure and dynamics of the skin to such an extent that adequate drug permeability can be achieved. This is known as permeation enhancement.

In order to develop and optimize transdermal patches capable of delivering a desired amount of a particular drug over time, it is important to understand the transdermal drug delivery process, particularly where permeation enhancers are required. Mathematical models that describe the diffusion of drugs in the skin, as well as in the drug-delivery device have been developed. See, for example, A. J. Lee. J. R. King, and T. G. Rogers, IMA J. Math. Appl. Med. & Biol. 13, 127 (1996); A. J. Lee, J. R. King and S. Hibbard, IMA J. Math. Appl. Med. & Biol. 15, 135 (1998). However, the complexity of the models already developed can lead to cumbersome expressions. The finite element method has also been used to model the diffusion and partitioning, but this method has mainly been limited to treatment of linear diffusion and constant partitioning. (See, for example, P. J. Missel, Annals Biomed. Eng., 28, 1307 (2000). It would be an improvement in the art, therefore, to provide a model describing a two-component diffusion process through heterogeneous domains, taking into account the partitioning of the compounds between different domains and possibilities of permeation enhancement. Such a model would permit further understanding of the transdermal diffusion of a drug with a permeation enhancer and could particularly valuable in the design and optimization of transdermal patches designed to utilize a permeation enhancer to achieve desired drug delivery performance characteristics.

### SUMMARY OF THE INVENTION

In one aspect of the present invention, the present invention includes a method of modeling multicomponent nonlinear diffusion in heterogeneous media. In particular, the finite element method has been employed to model nonlinear diffusion of two components through a heterogeneous media, with the diffusivities and partition coefficients taking on different values in each compartment. The diffusivities and partition coefficients were modeled as being concentration dependent, and the finite element formulation presented here is applicable to general functional forms for the diffusivities and partition coefficients. The capability to model concentration-dependent partitioning of the substances at the boundaries between the vehicle and the skin, and between the different layers of the skin is demonstrated using the Lagrange multiplier method. The Lagrange multiplier method, with the interface flux as Lagrange multipliers, allows a robust treatment of nonlinear partition coefficients.

In another aspect of the present invention, the model describing the nonlinear diffusion of two components through heterogeneous media created using the finite element method is applied to model transdermal drug delivery systems. In one embodiment, a simple two-layer domain is chosen to model a transdermal drug delivery system, with assumptions that the diffusivity and partition coefficient of the drug in the skin depend linearly on the enhancer concentration. The finite element results demonstrate the modeling capabilities and potentials of the finite element formulation.

### BRIEF DESCRIPTION OF THE DRAWINGS

FIG. 1 provides a schematic representation of heterogeneous domains of diffusion linked by interface flux.

FIG. 2 provides a schematic representation of the geometry of a transdermal delivery system.

FIG. 3 illustrates part of a finite element mesh.

FIG. 4 provides a graph illustrating drug flux through the lower boundary as a function of drug diffusivity in the skin as calculated by a model according to the present invention.

FIG. 5 provides a graph illustrating drug flux through the lower boundary as a function of the partitioning of the drug from the patch into the skin, as calculated by a model according to the present invention.

FIG. 6 provides a graph comparing the fentanyl flux calculated using a model according to the present invention to experimentally observed fentanyl flux with and without the presence of lauryl pyroglutamate (LP).

TABLE 1 describes diffusivities and partition coefficients calculated in runs 1-7 in Example 1. The diffusivities are in units of cm⁻²hr⁻¹, and the partition coefficients are dimensionless.

TABLE 2 provides the parameters values for the calculations in FIG. 7. The diffusivities are in units of cm⁻²hr⁻¹, and the partition coefficients are dimensionless.

### DETAILED DESCRIPTION OF THE INVENTION

The present invention includes a finite element formulation for multicomponent nonlinear diffusion in heterogeneous media. In the context of the present invention, the formulation is applicable to multicomponent nonlinear diffusion from a transdermal patch into skin, with diffusion and partition coefficients taking on different values in each subregion. The effect of permeation enhancers on the diffusion of the drug is modeled through both the concentration dependent diffusivity and partition coefficient. In addition, a Lagrange multiplier method for treating the nonlinear partition coefficient is described. Histologically, biochemically and functionally, the skin can be divided into the uppermost stratum corneum and underlying layers of the viable epidermis. In the present invention, however, we have simplified the problem by treating the stratum corneum and viable epidermis as a single homogenous domain.

### Mathematical Model

In one aspect, the present invention is directed to a finite element method for modeling the diffusion and partitioning of molecules between two compartments having different diffusion and partition coefficients for each diffusing species. The case where the partition coefficients are constant is treated in a straightforward manner by scaling the concentrations in each compartment by their respective partition coefficient, in effect defining a new continuous concentration variable for which the diffusion equation is solved. This method cannot be used when the partitioning is nonlinear, i.e., when the partition coefficients are concentration dependent. The difficulty of modeling a nonlinear partition coefficient, i.e., continuous flux and discontinuous concentration at the interface is overcome by the method of subdividing the domain into two subdomains, each corresponding to a separate compartment, and using independently defined Lagrange multipliers as fluxes on the interface to join the two subdomains. Therefore, the two subdomains are linked by the common interface flux (with opposite signs in each subdomain), and the constraint on the concentrations at the interface is enforced by a separate equation. (See, O. C. Zienkiewicz and R. L. Taylor, The Finite Element Method, 4^{th} ed., vol. 1, McGraw-Hill, 1989, pp. 373-376).

We consider a diffusion domain Ω, which is subdivided into two domains, Ω¹ and Ω², with the interface denoted Γ₁ (FIG. 1). The variables in each domain i are the two-component concentration vector

$$vector {c}^{i} = \{ \begin{matrix}{c}_{1}^{i} \\ {c}_{2}^{i}\end{matrix} \}$$

and the interface flux

$$flux λ = \{ \begin{matrix}{λ}_{1} \\ {λ}_{2}\end{matrix} \} .$$

The superscript in the notations indicates the relevant domain, and the subscript denote the component (the drug as component 1 and the enhancer as component 2). The general two-component diffusion equation in domain Ω¹ is

$$\begin{matrix}\frac{\partial {c}^{1}}{\partial t} - ∇ \cdot ( {D}^{1} ∇ {c}^{1} ) = 0 & on {Ω}^{1} \\ {c}^{1} = {g}^{1} & on {Γ}_{g}^{1} \\ - {D}^{1} {c}_{, n}^{1} = {h}^{1} & on {Γ}_{h}^{1} \\ - {D}^{1} {c}_{, n}^{1} = λ & on {Γ}_{I}\end{matrix} \qquad ( 1 )$$

Similarly, in domain Ω², setting the interface flux as −λ, we can write

$$\begin{matrix}\frac{\partial {c}^{2}}{\partial t} - ∇ \cdot ( {D}^{2} ∇ {c}^{2} ) = 0 & on {Ω}^{2} \\ {c}^{2} = {g}^{2} & on {Γ}_{g}^{2} \\ - {D}^{2} {c}_{, n}^{2} = {h}^{2} & on {Γ}_{h}^{2} \\ - {D}^{2} {c}_{, n}^{2} = - λ & on {Γ}_{I}\end{matrix} \qquad ( 2 )$$

where

$${D}^{i} = [ \begin{matrix}{D}_{11}^{i} & {D}_{12}^{i} \\ {D}_{21}^{i} & {D}_{22}^{i}\end{matrix} ]$$

is the diffusivity tensor in each domain.

An additional set of equations describing the concentration discontinuity of each species at the interface (i.e., partitioning) is needed to complete the set of equations,

$$\begin{matrix}\frac{{c}_{1}^{1}}{{k}_{1}^{1}} = \frac{{c}_{1}^{2}}{{k}_{1}^{2}} , & \frac{{c}_{2}^{1}}{{k}_{2}^{1}} = \frac{{c}_{2}^{2}}{{k}_{2}^{2}} & on {Γ}_{I}\end{matrix} \qquad ( 3 )$$

where kᵢ^{j} is the partition coefficient of component i in domain j. Equations (3) can be written as a matrix equation

$$\begin{matrix}\frac{1}{{k}^{1}} {c}^{1} - \frac{1}{{k}^{2}} {c}^{2} = 0 & & on {Γ}_{I}\end{matrix} \qquad ( 4 )$$

where

$$\frac{1}{{k}^{i}} = [ \begin{matrix}\frac{1}{{k}_{1}^{i}} & 0 \\ 0 & \frac{1}{{k}_{2}^{i}}\end{matrix} ]$$

is the partition coefficient matrix in each domain.

The initial concentration vectors are given as cⁱ(t=0)=cⁱ₀, and the initial interface flux is assumed to be zero.

Since the unknowns solved for involve both the concentrations and the interface flux, which is a derivative of the concentration, this becomes a mixed formulation.

The diffusion coefficients and partition coefficients in each subdomain are taken to be a function of the concentrations at the position and time (x, t), i.e.,

$${D}^{i} = [ \begin{matrix}{D}_{11}^{i} ( {c}_{1}^{i} , {c}_{2}^{i} ) & {D}_{12}^{i} ( {c}_{1}^{i} , {c}_{2}^{i} ) \\ {D}_{21}^{i} ( {c}_{1}^{i} , {c}_{2}^{i} ) & {D}_{22}^{i} ( {c}_{1}^{i} , {c}_{2}^{i} )\end{matrix} ] \\ \frac{1}{{k}^{i}} = [ \begin{matrix}\frac{1}{{k}_{11}^{i} ( {c}_{1}^{i} , {c}_{2}^{i} )} & 0 \\ 0 & \frac{1}{{k}_{22}^{i} ( {c}_{1}^{i} , {c}_{2}^{i} )}\end{matrix} ] \qquad ( 5 )$$

where c₁ⁱ=c₁ⁱ(x,t), c₂ⁱ=c₂ⁱ(x,t), and thus gives rise to a nonlinear diffusion and partitioning problem.

The set of equations (1), (2) and (4) along with the initial conditions describe our problem fully. Notice that in addition to the concentrations, which are normally the only solution to a diffusion problem, we are also solving for the interface flux between the two subdomains. This increases the size of the problem, but allows us to treat nonlinear partitioning between heterogeneous domains in a straightforward manner. Using the method of weighted residuals, the weak form of the equations (1), (2) and (4) can be found to be

$$\begin{matrix}{G}^{1} = {\int }_{{Ω}^{1}}^{} {v}^{{1}^{T}} \frac{\partial {c}^{1}}{\partial t} ⅆ Ω + {\int }_{{Ω}^{1}}^{} ∇ {v}^{{1}^{T}} {D}^{1} ∇ {c}^{1} ⅆ Ω + \\ {\int }_{{Γ}_{I}} {v}^{{1}^{T}} λ ⅆ Γ + {\int }_{{Γ}_{h}^{2}} {v}^{{1}^{T}} {h}^{1} ⅆ Γ \\ = 0 \\ {G}^{2} = {\int }_{{Ω}^{2}}^{} {v}^{{2}^{T}} \frac{\partial {c}^{2}}{\partial t} ⅆ Ω + {\int }_{{Ω}^{2}}^{} ∇ {v}^{{2}^{T}} {D}^{2} ∇ {c}^{2} ⅆ Ω - \\ {\int }_{{Γ}_{I}} {v}^{{2}^{T}} λ ⅆ Γ + {\int }_{{Γ}_{h}^{2}} {v}^{{2}^{T}} {h}^{2} ⅆ Γ \\ = 0 \\ C = {\int }_{{Γ}_{I}}^{} {w}^{T} ( \frac{1}{{k}^{1}} {c}^{1} - \frac{1}{{k}^{2}} {c}^{2} ) ⅆ Γ = 0\end{matrix} \qquad ( 6 )$$

where

$$v = \{ \begin{matrix}{v}_{1} \\ {v}_{2}\end{matrix} \} , \qquad w = \{ \begin{matrix}{w}_{1} \\ {w}_{2}\end{matrix} \}$$

are the weighting functions, and

$$∇ c = \{ \begin{matrix}∇ {c}_{1} \\ ∇ {c}_{2}\end{matrix} \} .$$

The unknowns c¹, c² and λ are discretized in the standard way

$${c}^{i} = N {\hat{c}}^{i} = [ ⋯ \begin{matrix}{N}_{a} & 0 \\ 0 & {N}_{a}\end{matrix} ⋯ ] \{ \begin{matrix}\begin{matrix}\begin{matrix}⋮ \\ {c}_{1 a}^{i}\end{matrix} \\ {c}_{2 a}^{i}\end{matrix} \\ ⋮\end{matrix} \} \\ λ = {N}_{λ} \hat{λ} = [ ⋯ \begin{matrix}{N}_{λ a} & 0 \\ 0 & {N}_{λ a}\end{matrix} ⋯ ] \{ \begin{matrix}\begin{matrix}\begin{matrix}⋮ \\ {λ}_{1 a}\end{matrix} \\ {λ}_{2 a}\end{matrix} \\ ⋮\end{matrix} \} \qquad ( 7 )$$

where N and N_{λ} are the shape functions and ĉⁱ and \hat{λ} are the nodal concentrations and interface flux. The weighting functions are also discretized similarly. Note that the shape functions for concentrations and flux are different.

Substituting (7) into (6), we get

$${G}^{1} = {\hat{v}}^{{1}^{T}} \{ {\int }_{{Ω}^{1}} {N}^{T} N ⅆ Ω \frac{\partial {\hat{c}}^{1}}{\partial t} + {\int }_{{Ω}^{1}} {B}^{T} {D}^{1} B ⅆ Ω {\hat{c}}^{1} + {\int }_{{Γ}_{l}} {N}^{T} {N}_{λ} ⅆ Γ \hat{λ} + {\int }_{{Γ}_{h}^{1}} {N}^{T} {h}^{1} ⅆ Γ \} = 0 \\ {G}^{2} = {\hat{v}}^{{2}^{T}} \{ {\int }_{{Ω}^{2}} {N}^{T} N ⅆ Ω \frac{\partial {\hat{c}}^{2}}{\partial t} + {\int }_{{Ω}^{2}} {B}^{T} {D}^{2} B ⅆ Ω {\hat{c}}^{1} - {\int }_{{Γ}_{l}} {N}^{T} {N}_{λ} ⅆ Γ \hat{λ} + {\int }_{{Γ}_{h}^{2}} {N}^{T} {h}^{2} ⅆ Γ \} = 0 \\ C = {\hat{w}}^{T} \{ {\int }_{{Γ}_{l}} {N}_{λ}^{T} \frac{1}{{k}^{1}} N ⅆ Γ {\hat{c}}^{1} - {\int }_{{Γ}_{l}} {N}_{λ}^{T} \frac{1}{{k}^{2}} N ⅆ Γ {\hat{c}}^{2} \} = 0 \\ where B = [ ⋯ \begin{matrix}{N}_{a , x} & 0 \\ 0 & {N}_{a , y} \\ {N}_{a , x} & 0 \\ 0 & {N}_{a , y}\end{matrix} ⋯ ] . \qquad ( 8 )$$

Since equations (8 must hold for arbitrary \hat{v}¹, \hat{v}², and ŵ they can be written equivalently in matrix form as

M¹\hat{\dot{c}}¹+K¹ĉ¹+K_{λ}\hat{λ}+f^{ext,1}=0

M²\hat{\dot{c}}²+K²ĉ²−K_{λ}\hat{λ}+f^{ext,2}=0

\tilde{K}_{λ}¹ĉ¹−\tilde{K}_{λ}²ĉ²=0 (9)

where

$${M}^{i} = {\int }_{{Ω}^{i}} {N}^{T} N ⅆ Ω , {K}^{i} = {\int }_{{Ω}^{i}} {B}^{T} {D}^{i} B ⅆ Ω , \\ {K}_{λ} = {\int }_{{Γ}_{l}} {N}^{T} {N}_{λ} ⅆ Γ , {\tilde{K}}_{λ}^{i} = {\int }_{{Γ}_{l}} {N}_{λ}^{T} \frac{1}{{k}^{i}} N ⅆ Γ , and$$

$${f}^{ext , i} = {\int }_{{Γ}_{k}^{i}} {N}^{T} {h}^{i} ⅆ Γ .$$

Collecting the unknowns together into the vector

$$\hat{c} = \{ \begin{matrix}{\hat{c}}^{1} \\ {\hat{c}}^{2} \\ \hat{λ}\end{matrix} \} ,$$

the system of equations (9) can be written compactly as

M\hat{v}+Kĉ+f=0 (10)

with

$$M = [ \begin{matrix}{M}^{1} & 0 & 0 \\ 0 & {M}^{2} & 0 \\ 0 & 0 & 0\end{matrix} ] , K = [ \begin{matrix}{K}^{1} & 0 & {K}_{λ} \\ 0 & {K}^{2} & - {K}_{λ} \\ {\tilde{K}}_{λ}^{1} & - {\tilde{K}}_{λ}^{2} & 0\end{matrix} ] , \hat{v} = \{ \begin{matrix}\begin{matrix}{{c}^{\dot{\hat{}}}}^{1} \\ {{c}^{\dot{\hat{}}}}^{1}\end{matrix} \\ 0\end{matrix} \} and$$

$$f = \{ \begin{matrix}\begin{matrix}{f}^{ext , 1} \\ {f}^{ext , 2}\end{matrix} \\ 0\end{matrix} \} .$$

Since \hat{λ} does not have a time derivative, it is excluded from the vector \hat{v}.

The system of equations (10) is in semidiscrete form, in that they are discrete in space but continuous in time. The time of simulation 0≦t≦t_{E} is now subdivided into equal time steps Δt such that tⁿ=nΔt, n=0, . . . , n_{TS}. ĉₙⁱ=ĉⁱ(tⁿ) and \hat{λ}ₙ=\hat{λ}(tⁿ) are the concentration and interface flux, respectively, at time step n. We use the generalized trapezoidal rule as the time integration method, which is also called the predictor-corrector method.

ĉₙ₊₁=\tilde{c}ₙ₊₁+αΔt\hat{v}ₙ₊₁

\tilde{c}ₙ₊₁=cₙ+(1−α)Δt\hat{v}ₙ (11)

Again, \hat{λ} is excluded from this predictor-corrector formulation, i.e., the velocity at time step n+1 is given by

$${\hat{v}}_{n + 1} = \{ \begin{matrix}{{c}^{\dot{\hat{}}}}_{n + 1}^{1} \\ {{c}^{\dot{\hat{}}}}_{n + 1}^{2} \\ 0\end{matrix} \}$$

Substituting (9) into (8) gives a set of nonlinear algebraic equations in the vector of unknowns ĉₙ₊₁,

$$0 = r ( {\hat{c}}_{n + 1} ) = \frac{1}{α Δ t} M ( {\hat{c}}_{n + 1} - {\tilde{c}}_{n + 1} ) + K {\hat{c}}_{n + 1} + {f}_{n + 1} \qquad ( 12 )$$

where r is called the residual.

The problem is now reduced to finding ĉₙ₊₁ so that the residual vanishes, i.e., r(ĉₙ₊₁)=0. The nonlinear algebraic equations (12) is solved using the robust Newton-Raphson method. Newton's method is an iterative procedure, where the iteration number is indicated by the superscript k, for the k-th iteration, ĉ^{k}=ĉₙ₊₁^{k}. The subscript n+1 indicating the time step number will be omitted in the following for simplicity. The starting value for the unknown is chosen to be the predictor for the time step, i.e., ĉ⁰=ĉₙ₊₁. The linearization of (12) results in

$$r ( {\hat{c}}^{k} ) + \frac{\partial r ( {\hat{c}}^{k} )}{\partial \hat{c}} Δ \hat{c} = r ( {\hat{c}}^{k} ) + ( \frac{1}{α Δ t} M + K + \frac{\partial K}{\partial \hat{c}} {\hat{c}}^{k} + \frac{\partial {f}_{n + 1}}{\partial \hat{c}} ) Δ \hat{c} = 0 \qquad ( 13 )$$

The equations (13) are solved for the increment in the unknown vector Δĉ, which is then added to the previous iterate

ĉ^{k+1}=ĉ^{k}+Δĉ (14)

The new solution is then checked for convergence.

For the case where the external forces are independent of the concentrations and interface fluxes, the specific matrix form of (13) is given by

$$[ \begin{matrix}\frac{1}{α Δ t} {M}^{1} + {K}^{1} + {K}_{nonlin}^{1} & 0 & {K}_{λ} \\ 0 & \frac{1}{α Δ t} {M}^{2} + {K}^{2} + {K}_{nonlin}^{2} & - {K}_{λ} \\ {K}_{λ}^{1} + {K}_{λ , nonlin}^{1} & - {K}_{λ}^{2} - {K}_{λ , nonlin}^{2} & 0\end{matrix} ] \{ \begin{matrix}\begin{matrix}Δ {\hat{c}}^{1} \\ Δ {\hat{c}}^{2}\end{matrix} \\ Δ \hat{λ}\end{matrix} \} = - [ \begin{matrix}\frac{1}{α Δ t} {M}^{1} + {K}^{1} & 0 & {K}_{λ} \\ 0 & \frac{1}{α Δ t} {M}^{2} + {K}^{2} & - {K}_{λ} \\ {K}_{λ}^{1} & - {K}_{λ}^{2} & 0\end{matrix} ] \{ \begin{matrix}\begin{matrix} {\hat{c}}^{1 , k} \\ {\hat{c}}^{2 , k}\end{matrix} \\ {\hat{λ}}^{k}\end{matrix} \} + \{ \begin{matrix}\begin{matrix}\frac{1}{α Δ t} {M}^{1} {\tilde{c}}^{1 , k} \\ \frac{1}{α Δ t} {M}^{2} {\tilde{c}}^{2 , k}\end{matrix} \\ 0\end{matrix} \} - \{ \begin{matrix}\begin{matrix}{f}^{ext , 1} \\ {f}^{ext , 2}\end{matrix} \\ 0\end{matrix} \}$$

where the extra stiffness matrices Kₙₒₙₗᵢₙⁱ and K_{λ,nonlin}ⁱ arise due to the nonlinearities of the diffusivity and partition matrices and therefore depend on the specific mathematical formula for Dⁱ and kⁱ.

$${K}_{nonlin}^{i} = \frac{\partial {K}^{i}}{\partial {\hat{c}}^{i}} {\hat{c}}^{i , k} = {\int }_{{Ω}^{i}} ( {B}^{T} \frac{\partial {D}^{i}}{\partial {\hat{c}}^{i}} B ) ⅆ Ω {\hat{c}}^{i , k} = {\int }_{{Ω}^{i}} ( {B}^{T} \frac{\partial {D}^{i}}{\partial {c}^{i}} NB ) ⅆ Ω {\hat{c}}^{i , k} \\ {K}_{λ , nonlin}^{i} = \frac{\partial {K}_{λ}^{i}}{\partial {\hat{c}}^{i}} {\hat{c}}^{i , k} = ( {\int }_{{Γ}_{l}} {N}_{λ}^{T} \frac{\partial ( 1 / {k}^{i} )}{\partial {\hat{c}}^{i}} N ⅆ Γ ) {\hat{c}}^{i , k} = ( {\int }_{{Γ}_{l}} {N}_{λ}^{T} \frac{\partial ( 1 / {k}^{i} )}{\partial {c}^{i}} {N }^{2} ⅆ Γ ) {\hat{c}}^{i , k} \qquad ( 15 )$$

All the matrices are assembled element by element in the usual way. Extension of the formulation to more than two layers and more than two components is straightforward.

It should be noted that the variational principle cannot be used to derive the correct weak form of the equation in this case because of the non-symmetric nature of the partitioning constraint.

If we write the total potential of the system in the standard way as

$${Π}^{*} ( c , λ ) = Π ( c ) + {\int }_{{Γ}_{l}}^{} {λ}^{T} ( \frac{1}{{k}^{i}} {c}^{1} - \frac{1}{{k}^{2}} {c}^{2} ) ⅆ Γ \qquad ( 16 )$$

where the total potential of the unconstrained system is

$$Π ( c ) = \frac{1}{2} {\int }_{Ω}^{} {c}^{T} ( \frac{\partial c}{\partial t} - ∇ \cdot ( D ∇ c ) ) ⅆ Ω + {\int }_{{Γ}_{h}}^{} {c}^{T} h ⅆ Γ$$

and

Ω¹∪Ω²=Ω

Γₕ¹∪Γₕ²=Γₕ

Γ_{g}¹∪Γ_{g}²=Γ_{g}

The stationarity of (14) leads to the set of equations

$${\int }_{{Ω}^{1}}^{} δ {c}^{{1}^{T}} \frac{\partial {c}^{1}}{\partial t} ⅆ Ω + {\int }_{{Ω}^{1}}^{} ∇ δ {c}^{{1}^{T}} {D}^{1} ∇ {c}^{1} ⅆ Ω + {\int }_{{Γ}_{h}^{1}}^{} δ {c}^{{1}^{T}} {h}^{1} ⅆ Γ + {\int }_{{Γ}_{l}}^{} δ {c}^{{1}^{T}} \frac{1}{{k}^{1}} λ ⅆ Γ = 0 \\ {\int }_{{Ω}^{2}}^{} δ {c}^{{2}^{T}} \frac{\partial {c}^{2}}{\partial t} ⅆ Ω + {\int }_{{Ω}^{2}}^{} ∇ δ {c}^{{2}^{T}} {D}^{1} ∇ {c}^{2} ⅆ Ω + {\int }_{{Γ}_{h}^{2}}^{} δ {c}^{{2}^{T}} {h}^{2} ⅆ Γ + {\int }_{{Γ}_{l}}^{} δ {c}^{{2}^{T}} \frac{1}{{k}^{2}} λ ⅆ Γ = 0 \\ {\int }_{{Γ}_{l}}^{} δ {λ}^{T} ( \frac{1}{{k}^{1}} {c}^{1} - \frac{1}{{k}^{2}} {c}^{2} ) ⅆ Γ = 0 \qquad ( 17 )$$

In contrast to the set of equations (8), equations (17) give rise to a symmetric tangent matrix. This is unreasonable physically because it amounts to scaling the flux at the interface by the partition coefficient, leading to creation or destruction of material at the interface between the two compartments.

The generalized trapezoidal rule used here for time integration is for linear problems, unconditionally stable for α≧0.5, and is accurate to second order when α=0.5, and accurate to first order otherwise. A problem with using this algorithm for the parabolic equation is the oscillation of the solution. Considering the homogeneous model equation

\dot{x}+ξx=0,

we see that the amplification factor

$$\frac{x ( ( n + 1 ) Δ t )}{x ( n Δ t )} = exp ( - ξ Δ t ) \approx \frac{( 1 - ( 1 - α ) ξ Δ t )}{1 + αξ Δ t}$$

is negative if ξΔt>1/(1−α). Therefore, for any α≠1, the numerical solution can exhibit spurious oscillations. For this reason, α=1 is used in our calculations. Because this results in solutions that are only first-order accurate, a small time step is used to compensate.

### Application of Mathematical Model to Transdermal System

Finding a permeation enhancer or combination of enhancers that achieves the targeted flux of the drug over the time that the patch is applied is often a fundamental task in the development of a transdermal formulations. The various factors that influence the flux of the drug are the geometry of the patch (e.g., area and thickness), the diffusivities in each domain, the partition coefficients of the drug and enhancers from the patch into the skin, and the dependence of the diffusivities and partition coefficients of each component on the concentrations of each component. In the present invention, we have formulated a mathematical model that allows the diffusivity and/or partition coefficient of the drug to be dependent on the concentrations of the drug itself as well as that of the enhancer, and vice versa. In this section, we demonstrate the effects of these nonlinearities on the flux of the drug in a simple model problem.

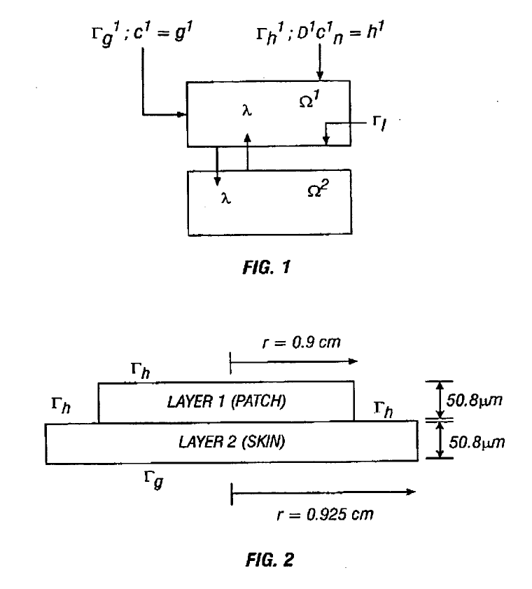

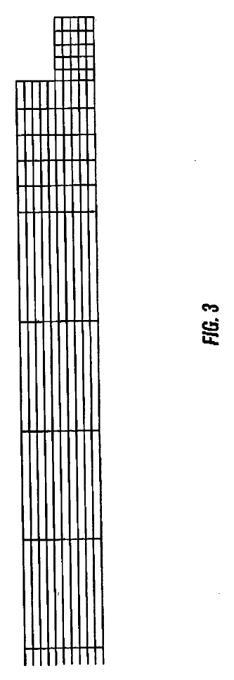

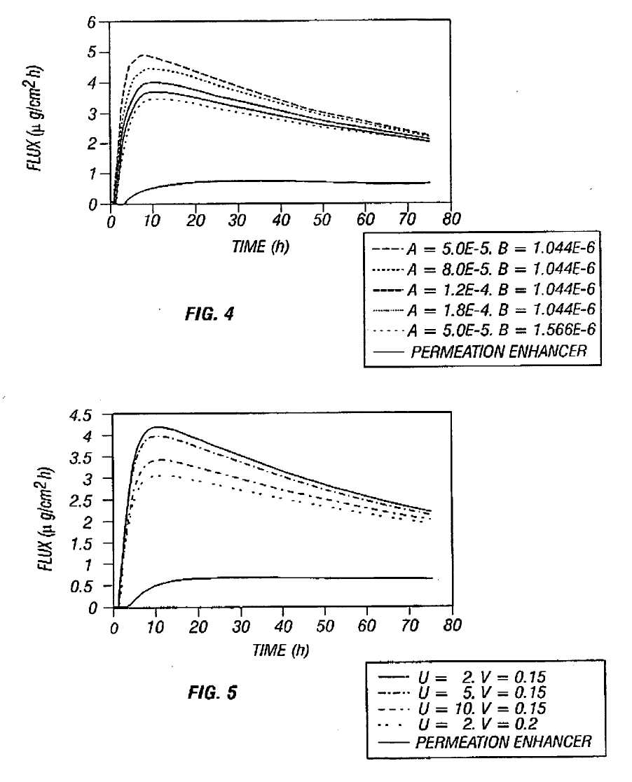

The diffusion domain Ω of consideration is composed of two cylindrical layers, the dermal patch (layer 1) and the skin (layer 2). A side view of the domain, along with its dimensions, is shown in FIG. 2. There are two diffusing species, the drug (component 1, with concentration c₁), and the permeation enhancer (component 2, with concentration c₂). The lower boundary (Γ_{g}) of the skin layer acts as a sink for both components, cᵢ=0, modeling the uptake of the drug and enhancer by the microcirculation system. The radius of the skin is set to be large enough so that the flux of the components across the sides of the skin domain is negligible. Also, it is assumed that no drug or permeation enhancer flow occurs through the top or the sides of the dermal patch, therefore simple zero flux boundary conditions are specified at all other boundaries (Γₕ). The dimensions of the patch is typical of an actual transdermal drug delivery device, and the skin thickness was chosen to match the thickness of skin used in the experimental studies, the results of which we want to compare to our calculations.

The formulation as we have stated above is very general, capable of modeling complicated nonlinear diffusivities and partition coefficients of a general mathematical form (5). In the present invention, rather than attempting to characterize all the different modeling possibilities, two aspects are isolated and the focus is drawn on the diffusivity and partitioning of the drug in the epidermis. In one embodiment, the mathematical model for our example problem is given as

$${D}^{1} = [ \begin{matrix}{D}_{11}^{1} & 0 \\ 0 & {D}_{22}^{1}\end{matrix} ] \\ \frac{1}{{k}^{1}} = [ \begin{matrix}\frac{1}{{k}_{11}^{1}} & 0 \\ 0 & \frac{1}{{k}_{22}^{1}}\end{matrix} ] \\ {D}^{2} = [ \begin{matrix}{D}_{11}^{2} & 0 \\ 0 & {D}_{22}^{2}\end{matrix} ] = [ \begin{matrix}A {c}_{2}^{2} + B & 0 \\ 0 & {D}_{22}^{2}\end{matrix} ] \\ \frac{1}{{k}^{2}} = [ \begin{matrix}\frac{1}{{k}_{11}^{2}} & 0 \\ 0 & \frac{1}{{k}_{22}^{2}}\end{matrix} ] = [ \begin{matrix}\frac{1}{U {c}_{2}^{2} + V} & 0 \\ 0 & \frac{1}{{k}_{22}^{2}}\end{matrix} ] \qquad ( 18 )$$

In other words, the cross-diffusivities are taken to be zero (i.e., a concentration gradient of one component does not give rise to a flux of the other component), and the diffusivity and the partition coefficient of the enhancer are assumed be constants in both the patch and skin layers as are the diffusivity and the partition coefficient of the drug in the patch. But the diffusivity and partition coefficient of the drug in the skin layer are linear functions of the enhancer concentration. Thus, the permeation enhancer is assumed to act (i.e., enhance the drug flux) through increasing both the diffusivity and partitioning of the drug in the skin layer. This linear form of the functions D₁₁² and k₁₁² is based on careful analysis of experimental drug fluxes for different drug and enhancer concentrations⁵.

With this model, using (13), the ij-th partition of the element nonlinear stiffness matrices (Kₙₒₙₗᵢₙⁱ)^{e} and (K_{λ,nonlin}ⁱ)^{e} are found to be

$${( {K}_{nonlin}^{i} )}_{i j}^{e} = {\int }_{{Ω}^{e}}^{} [ \begin{matrix}0 & A ( {N}_{i , 1} {c}_{1 , 1}^{i} + {N}_{i , 2} {c}_{1 , 2} ) \\ 0 & 0\end{matrix} ] {N}_{j} ⅆ {Ω \\ ( {K}_{λ , nonlin}^{i} )}_{i j}^{e} = {\int }_{{Γ}_{l}}^{} [ \begin{matrix}0 & - \frac{U {c}_{1}^{i}}{{( U {c}_{2}^{i} + V )}^{2}} {N}_{i} {N}_{j} \\ 0 & 0\end{matrix} ] ⅆ Γ \qquad ( 19 )$$

Part of the finite element mesh used for this problem is shown in FIG. 3. Since the problem is axisymmetric, the mesh is 2-dimensional with the use of axisymmetric elements. The mesh was generated with the MSC Patran software (available from MSC.Software Corporation in Santa Ana, Calif.) and consists of 275 4-node elements with 4 integration points for numerical quadrature. The finite element code that we used was developed in our research group, and has been used for several years for various classes of problems. The time stepping and iterative algorithms are as described in the previous section.

### EXAMPLE 1

The first series of calculations, runs 1 through 4, was performed for different values of the parameter A, keeping the values of all other parameters fixed. These values are tabulated in Table 1. For all runs, the initial drug concentration in the patch is 0.09 g/cm³, initial enhancer concentration in the patch is 0.08 g/cm³, and no drug or enhancer is initially present in the skin. The resulting drug flux through the lower boundary (Γ_{g}), i.e., the flux entering the bloodstream, is shown in FIG. 5.

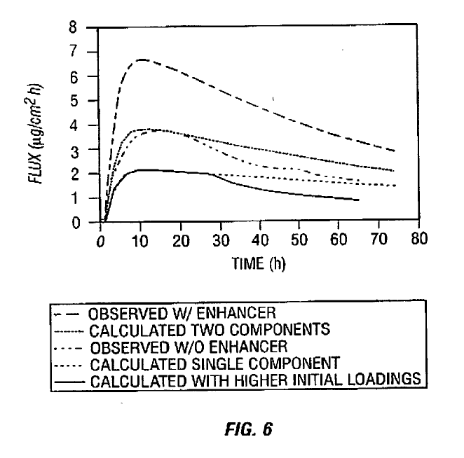

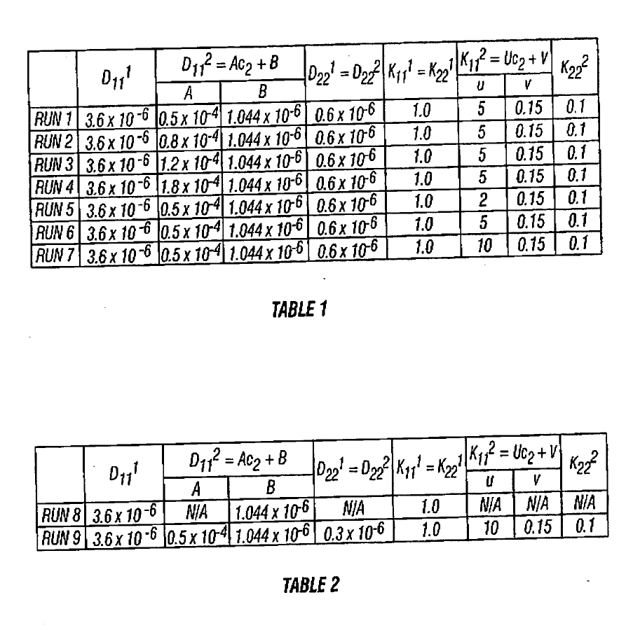

For runs 5 through 7, we kept the value of A at 0.5×10⁻⁴ cm⁻²hr⁻¹, and varied the value of the parameter U. The other parameter values were all fixed as in the previous runs, and are tabulated in Table 1. The units for the diffusivity parameters are in cm⁻²hr⁻¹, and the partition coefficient parameters are dimensionless (ratios of concentrations). The initial concentrations are the same as before, and the resulting fluxes through the boundary Γ_{g} are shown in FIG. 6 as a function of time.

The values of the parameters used in the calculations were chosen somewhat arbitrarily, due to the difficulty of obtaining experimental measurements. The base diffusivities of the drug in the patch and epidermis were selected to match the experimentally observed flux of fentanyl through a patch/skin system of the same dimensions (see FIG. 7). The diffusivity of the permeation enhancer was chosen to be significantly smaller than that for the drug based on some experimental indications (the exact value could not be found). The base partition coefficient of 0.15 of the drug in the skin layer is an experimentally measured value. The partition coefficient value 0.1 of the enhancer lauryl pyroglutamate in the skin is based on experimental measurements that yielded values ranging from 0.04 to 0.13. The partition coefficient of unity of the drug and enhancer in the patch reflects the fact that we are taking the patch to be the reference domain from which the drug and enhancer partition into the skin. All other parameters were selected somewhat arbitrarily, to demonstrate the sensitivity of the calculated flux to the changes in diffusivities and partition coefficients. The magnitude of the parameters A (˜10⁻⁴) and U (˜1) were chosen so that the terms Ac₂ and Uc₂ would be of the same order of magnitude as the base parameters B and V, respectively.

The results of the runs shown in FIGS. 5 and 6 are as expected, that is, as the diffusivity or the partitioning of the drug into the skin increases, the total drug delivered by a certain time (the cumulative flux or area under the flux curves) will increase. The concentration profile and the flux through the boundary Γ_{g} of the permeation enhancer are the same for runs 1 through 7, since the enhancer diffusion is linear with the same parameter values. Notice that for all the runs 1 through 7 the maximum flux occurs at the same point in time (around 11 hours) due to this, and the shapes of the flux curves are very similar. For comparison, the result for the case where the value of A was kept at 0.5×10⁻⁴ cm²hr¹/conc while the value of B was increased to 1.566×10⁻⁶ cm⁻²hr⁻¹ is also included in FIG. 5. In other words, the base diffusivity of the drug in the skin was increased while the effect of the enhancer concentration on the diffusivity was kept the same. It is noted that the flux increases with a steeper slope, reaching the maximum flux earlier in time, due to the fact that the diffusivity has increased uniformly, and the flux curve is on the whole shifted to the left. Compare this with FIG. 6, where the result for the run in which the value of V was kept at 5, while the value of U was increased to 0.2 is shown: the maximum flux is reached at the same time and the flux curve do not show a discernible difference in shape. This indicates that the functional form of the partition coefficient is less important than that of diffusivity in influencing the flux of the drug.

### EXAMPLE 2

The experimental flux data for the drug fentanyl with and without the permeation enhancer lauryl pyroglutamate (LP) is presented in FIG. 7. The data with fentanyl alone had an initial concentration of 0.08 g/cm³ fentanyl in the patch, whereas the enhanced data initially had 0.09 g/cm³ of fentanyl and 0.08 g/cm³ of LP in the patch. The calculated fluxes shown along with the data represent the finite element calculation results that most closely match the experimental data from a series of calculations with various parameter value combinations. The initial concentrations for the finite element calculations were the same as the initial experimental conditions. The values of the parameters used for the curves shown are tabulated in Table 2. The units here are again cm⁻²hr⁻¹ for the diffusivity parameters and dimensionless for the partition coefficient parameters. The single component calculation is a linear one, with constant diffusivities and partition functions. The diffusivity and partition coefficient that matched the single component experimental results most closely were then used as the base diffusivity and partition coefficient for the drug in the two-component calculation, resulting in a consist parameter set for the two calculations. Based on this set of parameters, a predictive calculation of drug flux with a higher initial concentration (“loading”) of the drug and enhancer in the patch is also shown in FIG. 7. This calculation was performed with initial patch concentrations of 0.12 g/cm³ and 0.1 g/cm³ for the drug and enhancer, respectively. It is interesting to note that this moderate increase in the initial loading for the drug and enhancer (of around 30 and 25%, respectively) increases the peak drug flux almost two-fold.

Due to the large number of parameters values that can be varied, along with the nonlinear character of the problem, we have not attempted to rigorously fit the experimental data to the finite element results based on our mathematical model. The curves shown here represent the results that most closely match the observed data among a series of calculations that we have performed. Even at this level, however, comparison of the curves reveals some interesting points. The single set of parameters of run 9 in Table 2 captures the rise of the flux to its peak value reasonably well, for both the single component and two-component diffusion. In contrast, the rapid decrease in flux in the tail part of the observed curves are not reproduced as well in either case, although the discrepancy is slightly smaller for the multicomponent diffusion. As this rapid drop in flux after reaching the peak is present (in fact, even more pronounced) in the single component linear diffusion, it seems that our 2-layer model of the patch and skin with linear Fick's law is too simple to describe the transdermal diffusion process fully. The skin, although it is treated as a homogeneous continuum domain in this work, actually has a complex structure consisting of the stratum corneum, the epidermis and the dermis layers (didn't mention the dermis in the intro), all of which present a different environment to the diffusing drug and enhancer components. In addition, the patch used in the experiments has an occlusive backing, causing water retention, which results in swelling of the patch as well as increased hydration of the skin covered by the patch. The effect that this increased water content has on the diffusion process is currently not well understood, but it is highly probable that it would result in changes in the diffusion and partition coefficients, perhaps with time, as the hydration level increases.

We claim:

1. A method for modeling nonlinear diffusion of a multicomponent system in heterogeneous media.

2. The method of claim 1, further comprising the step of applying a Lagrange multiplier method for treating the nonlinear partition coefficient of one or more components included in the multicomponent system.

3. The method of claim 1, wherein the method is applied to multicomponent diffusion through two or more subdomains and the diffusion coefficients and partition coefficients in each subdomain are respectively taken to be
$${D}^{i} = [ \begin{matrix}{D}_{11}^{i} ( {c}_{1}^{i} , {c}_{2}^{i} ) & {D}_{12}^{i} ( {c}_{1}^{i} , {c}_{2}^{i} ) \\ {D}_{21}^{i} ( {c}_{1}^{i} , {c}_{2}^{i} ) & {D}_{22}^{i} ( {c}_{1}^{i} , {c}_{2}^{i} )\end{matrix} ]$$
$$\frac{1}{{k}^{i}} = [ \begin{matrix}\frac{1}{{k}_{11}^{i} ( {c}_{1}^{i} , {c}_{2}^{i} )} & 0 \\ 0 & \frac{1}{{k}_{22}^{i} ( {c}_{1}^{i} , {c}_{2}^{i} )}\end{matrix} ]$$
where c₁ⁱ=c₁ⁱ(x,t), c₂ⁱ=c₂ⁱ(x,t).

4. A method for modeling nonlinear diffusion of a drug and a permeation enhancer in a heterogeneous transdermal system.

5. The method of claim 4, further comprising the step of applying a Lagrange multiplier method for treating the nonlinear partition coefficient of one or more components included in the multicomponent system.

6. The method of claim 5, wherein the method is applied to diffusion of the drug and the permeation enhancer through two or more subdomains and the diffusion coefficients and partition coefficients of the drug and the permeation enhancer in each subdomain are respectively taken to be
$${D}^{i} = [ \begin{matrix}{D}_{11}^{i} ( {c}_{1}^{i} , {c}_{2}^{i} ) & {D}_{12}^{i} ( {c}_{1}^{i} , {c}_{2}^{i} ) \\ {D}_{21}^{i} ( {c}_{1}^{i} , {c}_{2}^{i} ) & {D}_{22}^{i} ( {c}_{1}^{i} , {c}_{2}^{i} )\end{matrix} ]$$
$$\frac{1}{{k}^{i}} = [ \begin{matrix}\frac{1}{{k}_{11}^{i} ( {c}_{1}^{i} , {c}_{2}^{i} )} & 0 \\ 0 & \frac{1}{{k}_{22}^{i} ( {c}_{1}^{i} , {c}_{2}^{i} )}\end{matrix} ]$$
where c₁ⁱ=c₁ⁱ(x,t), c₂ⁱ=c₂ⁱ(x,t).
